(19) United States
(12) Patent Application Publication
(10) Pub. No.: US 2019/0012623 A1
(43) Pub. Date: Jan. 10, 2019

(54) TRADE MANAGEMENT METHOD, TRADE MANAGEMENT SYSTEM AND TRADE MANAGEMENT DEVICE

(71) Applicant: HITACHI, LTD., Tokyo (JP)

(72) Inventors: Takayuki HABUCHI, Tokyo (JP); Hirofumi NAGANO, Tokyo (JP); Masayuki OYAMATSU, Tokyo (JP); Itaru NISHIZAWA, Tokyo (JP)

(21) Appl. No.: 15/913,951

(22) Filed: Mar. 7, 2018

(30) Foreign Application Priority Data
Jul. 4, 2017 (JP) 2017-130784

(51) Int. Cl. G06Q 10/06; G06F 17/30

(52) U.S. Cl. CPC G06Q 10/0635; G06F 17/30194

(57) ABSTRACT

A product and the like can be managed after trading the product and the like to reduce trade risks. A trade management system includes a node having a calculating unit that performs, with transaction data issued by a predetermined node on an occasion of selling a predetermined product being set as a start point, processing for determining whether or not a commercial trade is valid on the basis of information on a trade condition of the product included in transaction data at the start point, and preliminarily held party-in-charge information relating to the party in charge when performing each processing of a series of commercial trades for repeating purchase and sale of the product.

### CROSS-REFERENCE TO RELATED APPLICATION

This application claims priority pursuant to 35 U.S.C. § 119 from Japanese Patent Application No. 2017-130784, filed on Jul. 4, 2017, the entire disclosure of which is incorporated herein by reference.

### BACKGROUND

The present invention relates to a trade management method, a trade management system, and a trade management device and, more specifically, relates to a technology for enabling management of a product and the like after trading the product and the like to reduce trade risks.

As one distributed ledger technology, a so-called blockchain technology whose application to services in various industries is researched. With the blockchain technology, by using a Peer-to-Peer (P2P)-based distribution-type server, a configuration to secure the authenticity of a trade is proposed. See Bitcoin: A Peer-to-Peer Electronic Cash System (Satoshi Nakamoto, https://bitcoin.org/bitcoin.pdf).

In addition to the viewpoint of the authenticity of the trade as mentioned above, consideration to management of products and services handled in the trade is important in viewpoint of production responsibility, sales responsibility, and the like.

Accordingly, as a management technology of the product and services handled in a trade, for example, a sub-system for guaranteeing the quality, safety, and/or environment performance of a product is built in an electro-commerce trade system in which a purchasing side purchases, via an electronic commercial market, a product sold by a selling side. The sub-system has a database for storing numerical characteristics that characterize a rule, a standard, and/or a request specification relating to the quality, safety, and/or environment performance when making an electronic commercial trade, and enabling viewing from both the purchasing side and the selling side. Such an electronic commercial trade system is proposed that the selling side delivers a product that guarantees the product quality, safety, and/or environment performance relating to numerical characteristics that characterize the rule, standard, and/or request specification to the purchasing side, and when determining success or failure by inspecting whether or not the delivered product satisfies the rule, standard, and/or request specification, the purchasing side guarantees the correctness of a measurement value for determining success or failure of the numerical characteristics that characterize the rule, standard, and/or request specification. See International Publication No. WO2007/129488.

Considering a case in which a maker and a seller may be held liable for manufacturing or selling even after having sold a product and the like, it is desirable that the product and the like which has already been sold is properly managed.

However, it is originally difficult to manage the treatment of the product and the like which has been already sold. The conventional technology cannot cope with such a situation. In particular, manufacturing industries are in such a situation that supply chains are globalized and a large number of companies across countries relate to trades, and the level of difficulty for management thereof is further increased. In addition, a form of the electronic commerce via the Internet is general for such trades. Trades with an unknown third party may not ensure proper treatment of a product and the like after selling and, may lead to various trade risks.

### SUMMARY

An object of the invention is to provide a technology to enable management of a product and the like after trading the product and the like to reduce trade risks.

A trade management method according to the present invention implemented, in a system including a plurality of nodes that individually hold transaction data in a commercial trade by a distributed ledger, by a node used by a party in charge of the commercial trade, comprises, with transaction data issued by a predetermined node on an occasion of selling a predetermined product being set as a start point, determining whether or not the commercial trade is valid on the basis of information on a trade condition of the product included in the transaction data at the start point, and preliminarily held party-in-charge information relating to the party in charge when performing each processing of a series of commercial trades for repeating purchase and sale of the product.

In addition, a trade management system according to the invention includes: a plurality of nodes that individually hold transaction data in a commercial trade by a distributed ledger. A node used by a party in charge of the commercial trade performs, with transaction data issued by a predetermined node on an occasion of selling a predetermined product being set as a start point, processing for determining whether or not the commercial trade is valid on the basis of information on a trade condition of the product included in the transaction data at the start point, and preliminarily held party-in-charge information relating to the party in charge when performing each processing of a series of commercial trades for repeating purchase and sale of the product.

Further, a trade management device according to the invention includes: a node that holds transaction data in a commercial trade and forms a distributed ledger system. The node includes a calculating unit that performs, with transaction data issued by a predetermined node on an occasion of selling a predetermined product being set as a start point, processing for determining whether or not the commercial trade is valid on the basis of information on a trade condition of a product included in the transaction data at the start point, and preliminarily held party-in-charge information relating to the party in charge when performing each processing of a series of commercial trades for repeating purchase and sale of the product.

Furthermore, a non-transitory computer-readable medium containing a trade management program according to the invention that causes a node that holds transaction data in a commercial trade and forms a distributed ledger system to, with transaction data issued by a predetermined node on an occasion of selling a predetermined product being set as a start point, determine whether or not the commercial trade is valid on the basis of information on a trade condition of the product included in the transaction data at the start point, and preliminarily held party-in-charge information relating to the party in charge when performing each processing of a series of commercial trades for repeating purchase and sale of the product.

According to the invention, it is possible to enable management of a product and the like after trading the products and the like to reduce trade risks.

### BRIEF DESCRIPTION OF THE DRAWINGS

FIG. 1 is a diagram of a network configuration including a trade management system according to an embodiment of the invention;

FIG. 2 is a diagram showing an example of a user management data according to the embodiment;

FIG. 3 is a diagram showing a transaction example according to the embodiment;

FIG. 4 is a diagram showing an example of transaction data according to the embodiment;

FIG. 5 is a diagram showing an example of traceability data according to the embodiment;

FIG. 6 is a flow chart showing an exemplary procedure of a selling-side trading method according to the embodiment;

FIG. 7 is a diagram showing an output example of a selling-side list according to the embodiment;

FIG. 8 is a diagram showing an output example of registering a new selling-side according to the embodiment;

FIG. 9 is a diagram showing an example of a selling-side order transaction according to the embodiment;

FIG. 10 is a diagram showing an output example of selling-side specific information according to the embodiment;

FIG. 11 is a diagram showing a transaction example of changing a selling-side condition according to the embodiment;

FIG. 12 is a diagram showing a transaction example of canceling a trade on the selling side according to the embodiment;

FIG. 13 is a flow chart showing an exemplary procedure of a purchasing-side trading method according to the embodiment;

FIG. 14 is a diagram showing an output example of a receiving selling-side list according to the embodiment;

FIG. 15 is a diagram showing an output example of a selling-side search according to the embodiment;

FIG. 16 is a diagram showing an output example of a check of a selling-side condition according to the embodiment;

FIG. 17 is a diagram showing an exemplary trade completing transaction according to the embodiment; and

FIG. 18 is a diagram showing a transaction example of canceling a purchasing-side trade according to the embodiment.

### DETAILED DESCRIPTION OF EMBODIMENTS

Network Configuration

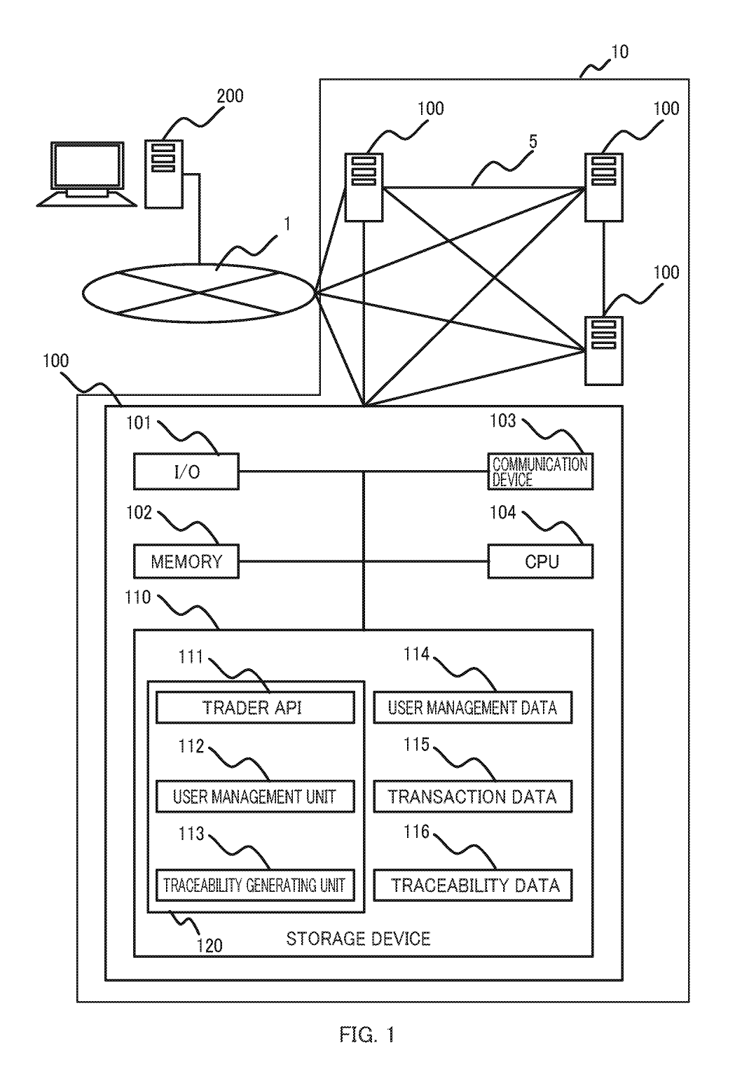

A specific description will be given below of an embodiment of the invention with reference to drawings. FIG. 1 is a diagram of a network configuration including a trade management system 10 according to the embodiment. The trade management system 10 shown in FIG. 1 is a computer system that can manage a product and the like after trading the product and the like to reduce trade risks.

The trade management system 10 according to the embodiment includes nodes 100 that are connected to be mutually communicable via a P2P network 5. The node 100 is a trade management device 100 according to the embodiment, and is included in a distributed ledger system. That is, the trade management system 10 according to the embodiment is included in the distributed ledger system.

In the distributed ledger system, a node called a miner performs determination about the validity on transaction data, i.e., transaction data on the P2P network, and performs determining processing with an operation of calculating a specific hash value called a proof of work. The above-determined transaction data is grouped into one block, and is recorded in a distributed ledger called a blockchain. That is, the distributed ledger is equally provided for each node, and distributed ledgers are kept in synchronization across nodes.

Note that, referring to FIG. 1, four nodes 100 are shown as examples, however, the number of nodes is not limited. In addition, in the above description, as an example of determining whether or not the transaction data is valid, determining processing of proof of work is exemplified. However, a method used in the trade management system 10 is not limited thereto.

The above-mentioned P2P network 5 is connected to the network 1, via which the individual nodes 100 as trade management devices can communicate data with a client terminal 200.

The client terminal 200 is a terminal that accesses a trader API 111 of the node 100 via the network 1 and the P2P network 5 to acquire data from the nodes 100, and performs processing for displaying the data on a display and processing for receiving an input from a user who uses the client terminal 200.

Note that recently various derived technologies based on the above-mentioned blockchain technology are proposed and continuously advanced. As a main characteristic of the current blockchain, there are the followings: (1) in trades between participants on a blockchain network, in place of a centralized organization, an (arbitrary or specific) participant determines a trade by consensus building or approval; (2) a plurality of transaction data is grouped into as a block, is recorded in a cascaded manner to the distributed ledger, and continuous blocks are hash-calculated to substantially disable falsification; and (3) all participants share the same ledger data (distributed ledger), thereby enabling the check of the trade by all the participants.

With the above characteristics, application to wide fields of the blockchain technology such as finance, Internet of Thing (IoT), or the like are examined as a system for performing management/sharing of reliable data and enforcement/management of a trade based on contract. By using an infrastructure for providing the blockchain (hereinbelow, the infrastructure of the blockchain), thereby sharing information between a plurality of subjects and performing trades without management by the centralized organization (for example, a consortium of a specific field or a plurality of companies relating to a supply chain).

In addition, such a system is born to enable the blockchain to be applied to not only trade of a simple virtual currency such as bitcoin, but also a complicated trade condition and various applications. In the blockchain, not only (transaction) data but also logic can be managed. The logic is called smart contract.

In the infrastructure of the blockchain having an execution function of the above-mentioned smart contract, the smart contract itself and input data to the smart contract are managed. To be brief, the smart contract itself is something like a function (or functions). The input data then turns out to be something like a smart contract and a function name to be called, or an argument provided to the function. With the execution function of the smart contract, a trade can be made in accordance with a pre-defined contract.

Herein, the smart contract and input data thereof are managed in a cascaded manner with a signature in the blockchain. Therefore, the infrastructure of the blockchain having the execution function of the smart contract is provided, a register of the data and the logic is thus clear, and it can usually be checked that registered contents are not changed. With the base of the technological background, the trade management system 10 according to the embodiment is operated.

In addition, a hardware configuration of the node 100 is as follows. That is, the node 100 includes a storage device 110 having a non-volatile storage device such as a hard disk drive, a memory 102 having a volatile storage device such as a random access memory (RAM), a central processing unit (CPU) 104 that reads a program 120 stored in the storage device 110 to the memory 102 to integrally control the system and performs various determinations, calculations, and control processing, and a communication device 103 that is connected to the network 1 or the P2P network 5 and performs communication processing with another device (another node or the client terminal 200).

Note that, as the function attached to the above-mentioned storage device 110, there are a trader API111, a user management unit 112, and a traceability generating unit 113. The CPU 104 performs the corresponding program 120, thereby attaching the functions.

In addition, as data to be stored in the storage device 110, there are user management data 114, transaction data 115, and traceability data 116. In the node 100 shown in FIG. 1, the various functions and databases for storing data used by the various functions are exemplified.

Data Structure Example

Subsequently, a description will be given of data or the like used in the individual nodes 100 forming the trade management system 10 according to the embodiment.

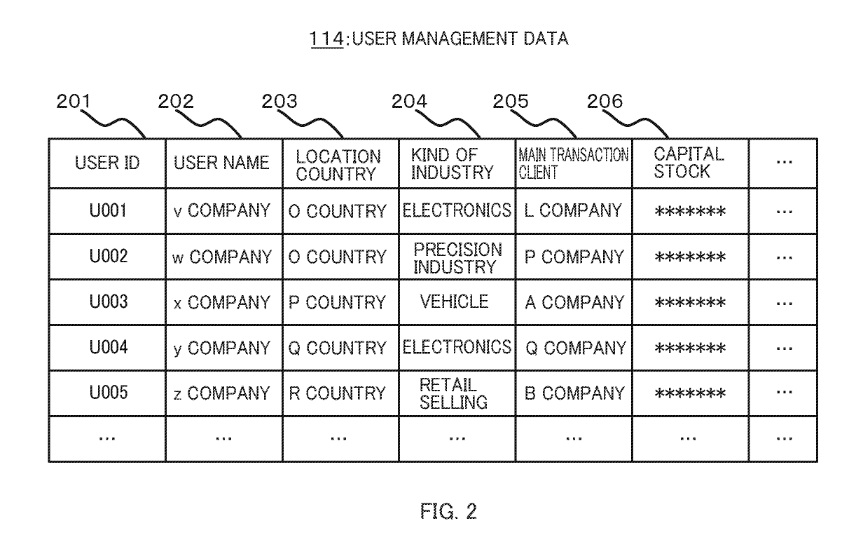

FIG. 2 shows an example of the user management data 114 according to the embodiment. The user management data 114 is a table that stores attribute information of a user who uses the node 100.

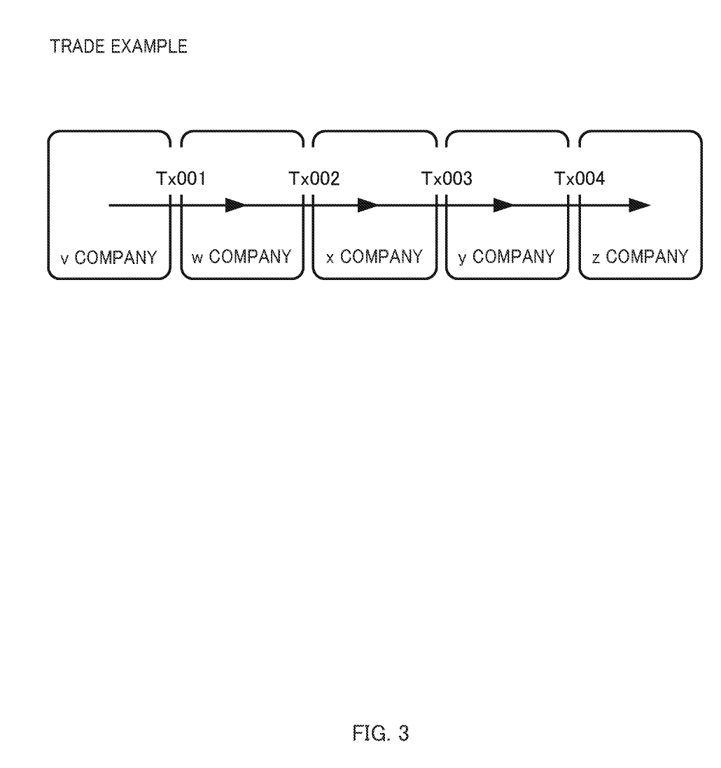

The data structure with a user ID for uniquely specifying the user as a key is a set of records of data having a user name 202 indicating a name of the user, a location country 203 indicating a country where the user is located, a kind of belonging industry 204, a main trade client 205, and a capital stock 206. As the attribute information, additionally, items on receivable and legal compliance, information useful to a commercial trade can be assumed. Note that addition, change, and deletion of a new record in the user management data 114 are performed by the user management unit 112 in response to a request from, for example, a predetermined node 100 or the client terminal 200. Subsequently, a description will be given of examples of the transaction data 115 and the traceability data 116 according to the embodiment with reference to FIGS. 3 to 5.

FIG. 3 shows a flow chart of a series of commercial trades. In the flow of the commercial trades, a product is sold from a v-company on the selling side to a w-company on the purchasing side. In addition, the w-company is set as the selling side, the product is sold to an x-company on the purchasing side. Subsequently, the product is also from the x-company to a y-company, from the y-company to a z-company, that is, sequential selling and purchasing. As a consequence, ownership is shifted between the companies. Herein, relating to individual trade opportunities forming the series of commercial trades, as a trade ID, “Tx001”, “Tx002”, “Tx003”, and “Tx004” are assigned.

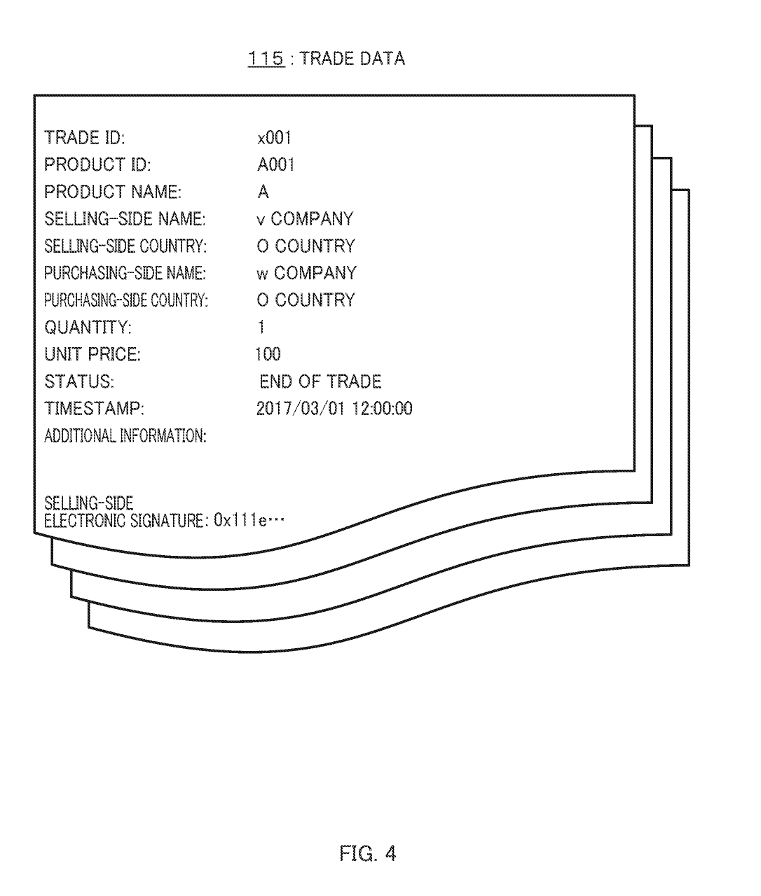

In the flow of the commercial trades, the node 100 as the party in charge of the trade issues transaction data for each trade opportunity. FIG. 4 shows an example of the transaction data 115 according to the embodiment. Herein, in the above-mentioned flow of commercial trades, the transaction data 115 is shown, relating to a trade opportunity (trade ID “Tx001”) in which a product “A” is sold from the v-company to the w-company.

With a trade ID that uniquely specifies the trade as a key, the transaction data 115 according to the embodiment corresponds to values such as a product ID that uniquely specifies a product handled in a trade, a product name indicating a name of the product, a selling-side name indicating a name of the selling side of the trade, a selling-side country indicating the location country of the selling side of the trade, a purchasing-side name indicating a name of the purchasing side of the trade, a purchasing-side country indicating a location country of the purchasing side of the trade, a quantity indicating a quantity of trade, a unit-price indicating a unit-price of the trade, a status indicating a situation of the trade, “Timestamp” indicating the date and time when the transaction data is registered, additional information indicating a trade condition, and a selling-side electronic signature indicating the authenticity of the transaction data.

Note that in the transaction data 115 according to the embodiment forming the blockchain, the above-mentioned selling-side electronic signature includes information about a trade one-before a series of commercial trades. The selling-side electronic signature is traced, thereby enabling the trace of the history of a series of commercial trades towards the past. It is assumed that the characteristic functions, configurations and the like in the blockchain are similar to those in a trade management method according to the embodiment.

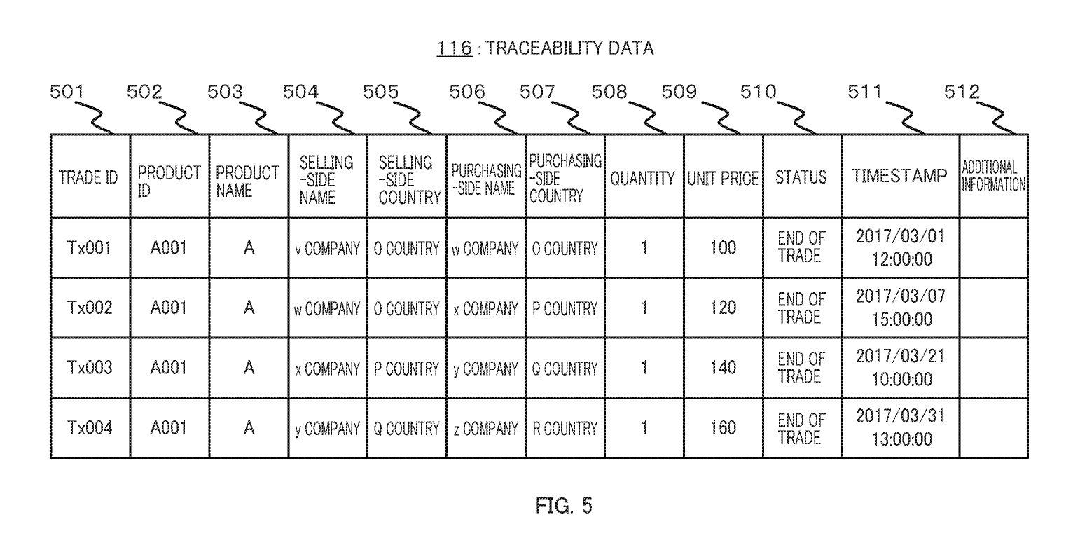

Subsequently, FIG. 5 shows an example of the traceability data 116 according to the embodiment. Regarding the trade history of a series of commercial trades shown in FIG. 3 as examples, the traceability data 116 is a table that is extracted by using the selling-side electronic signature of each of the above-mentioned transaction data 115 and arranges information about the trade history in time-sequential order. Note that a traceability data generating function 113 generates the above-mentioned traceability data 116.

Flow Example 1

Hereinbelow, a description will be given of an actual sequence of the trade management method according to the embodiment with reference to the drawings. Various operations corresponding to the trade management method, which will be described below are realized under a program read into a memory or the like and executed by the individual nodes 100 forming the trade management system 10. Further, the program includes codes for various operations, which will be described below.

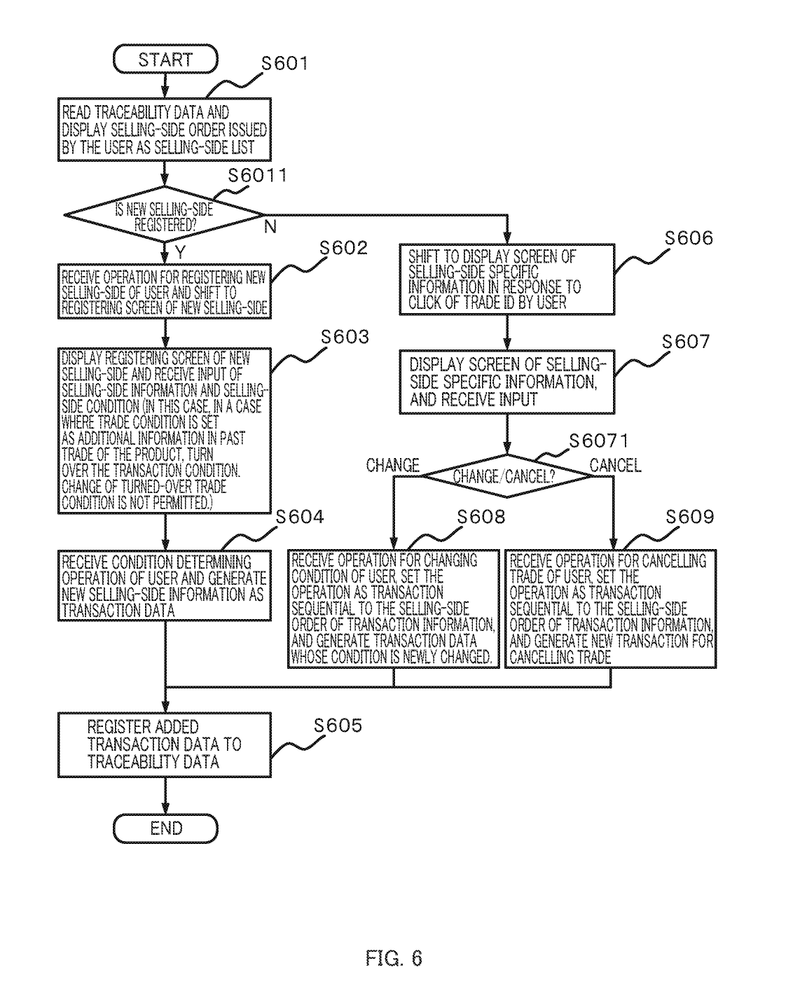

FIG. 6 is a diagram showing a flow example 1 of the trade management method according to the embodiment. Herein, a description will be given of processing sequences by the trader API 111 and the traceability generating unit 113 for generating the selling-side order transaction, changing the selling-side order transaction, and canceling the selling-side order transaction.

Note that the flow is started by executing the trader API 111 of the predetermined node 100 via the network 1 and the P2P network 5 with the client terminal 200 by the user as the party in charge who desires selling of a commercial product.

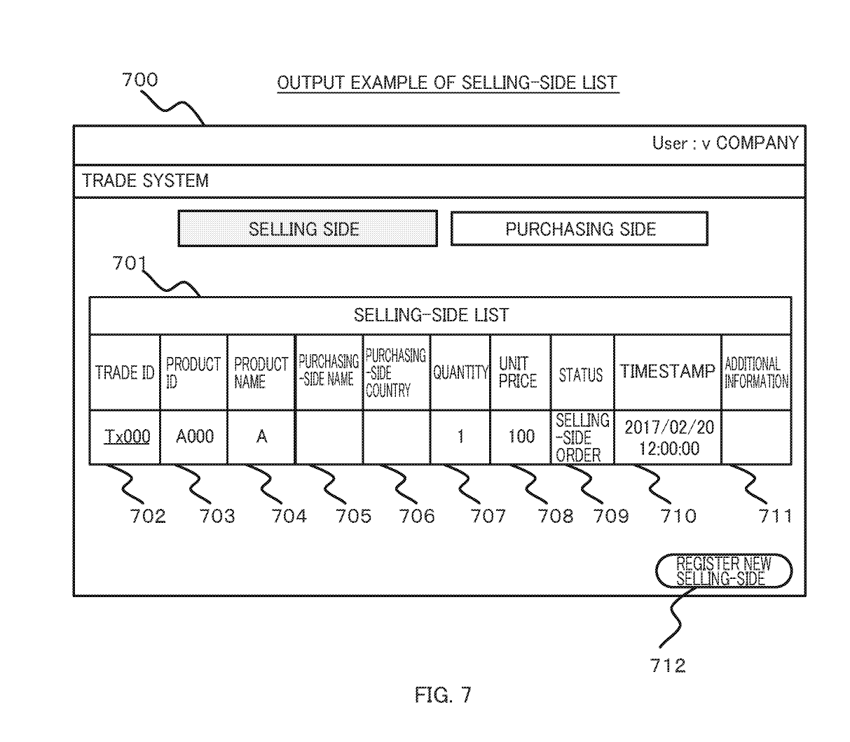

Herein, the trader API 111 of the above-mentioned node 100 reads the traceability data 116, extracts information (of the user specified as “the selling-side name”) of the selling-side order issued by the user, generates the information as a selling-side list 701, and displays a selling-side list screen 700 (FIG. 7) including this on the above-mentioned client terminal 200 (S601). Obviously, the individual nodes 100 store in advance data for display on the screen on the storage device 110, and can properly read and use the data (the same goes below).

On the selling-side list screen 700, if the user clicks a new selling-side registering button 712 (YES at S6011), the trader API 111 of the node 100 shifts the processing to S602.

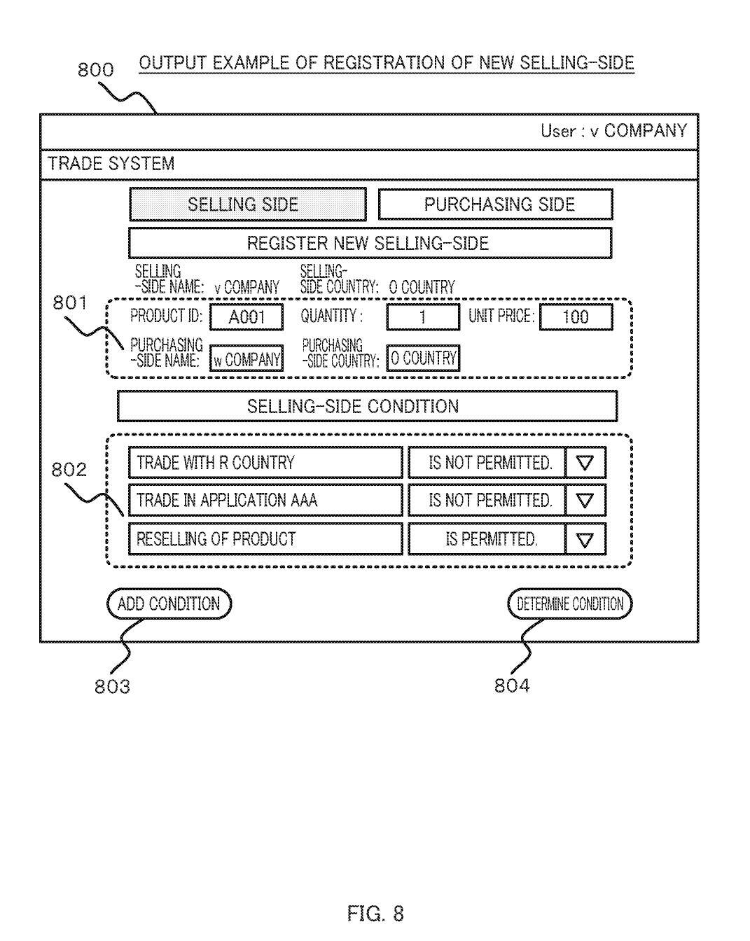

Subsequently, in response to the click operation of the above-mentioned new selling-side registering button 712, the trader API 111 of the node 100 shifts the display screen distributed to the client terminal 200 to a new selling-side registration screen 800 (FIG. 8) (S602).

The above-mentioned user operates the client terminal 200 to input a product desired to be sold thereby, a trade condition thereof, and the like to input items on the new selling-side registration screen 800.

On the other hand, the trader API 111 of the node 100 receives information input by the client terminal 200 as mentioned above, i.e., selling-side information 801 having values of a product ID for a selling product, the quantity, the unit price, the purchasing-side name, and the purchasing-side country and information about a selling-side condition 802 that prescribes the trade condition (S603). In the selling-side condition 802 as the trade condition shown in FIG. 8, such prescriptions are set in viewpoint of the selling side, including “a trade with an R country is not permitted”, “a trade is not permitted for application AAA”, and “reselling of a product is permitted”.

In a column of the selling-side condition 802, in order to manage trade risks relating to the items handled in the trade in one trade opportunity after ending another trade opportunity, a condition for a trade, that is, a trade condition is set.

Note that when the trader API 111 of the node 100 displays a column of the selling-side condition 802 on the client terminal 200, in a case where the traceability data 116 can search and specify the trade condition set about the past trade of the product, preferably, the trade condition is displayed as a preset one (in the example in FIG. 8, for example, the item “Trade with the R country”). In addition, when receiving a click of a condition adding button 803, the trader API 111 of the node 100 adds and displays another vacant input column on the column of the selling-side condition 802 on the new selling-side registration screen 800, and receives an input of the user of a new selling-side condition in the input column.

The node 100 according to the embodiment sets the trade condition that receives an input and designation of the user in the column of the selling-side condition 802 as effective and no falsification (specific effect of the blockchain) in any subsequent trade opportunity, regarding a product to be handled in the trade (a product “A001” designated in the column of “product ID” of the selling-side information 801). It is possible to manage trade risks of the trade opportunity after the next selling-side (the selling-side name “v company” in the example in FIG. 8) sells the product “A001”.

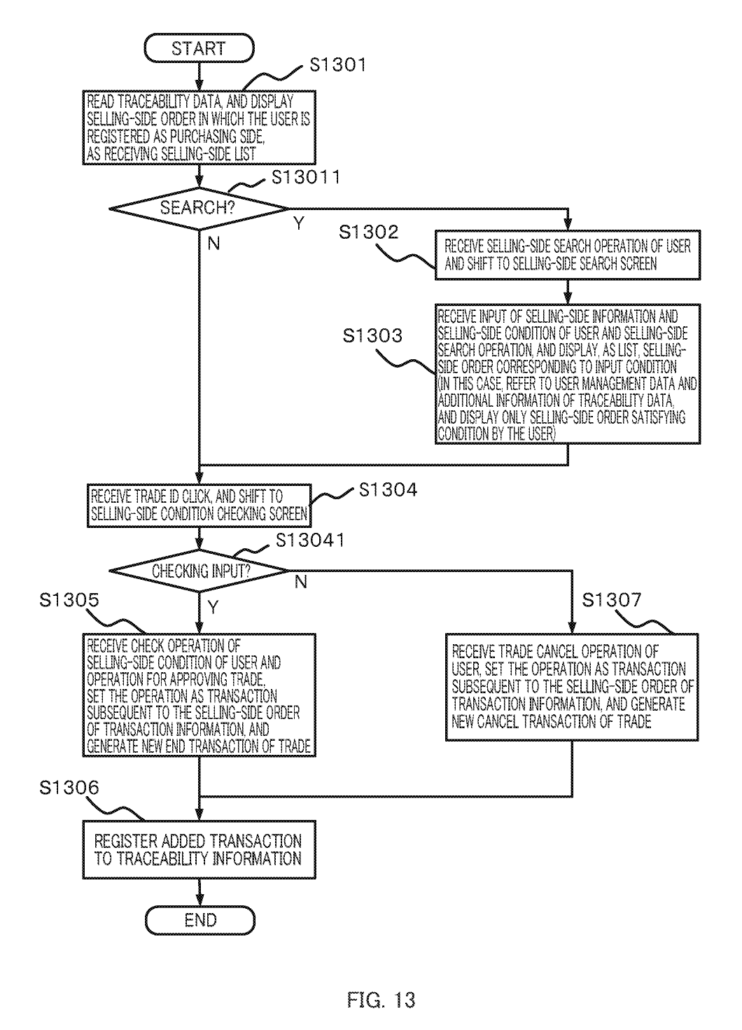

In addition, when the above-mentioned user inputs data of individual traders, regarding the purchasing-side name and the purchasing-side country of the selling-side information 801, it is assumed that the trader API 111 of the node 100 issues transaction data of selling-side order to the purchasing side. On the other hand, in a case where the user does not particularly set the purchasing-side name and the purchasing-side country of the selling-side information 801 as vacant, the trader API 111 of the node 100 generates and issues transaction data as selling-side order that can be searched by the user, satisfying the trade condition in processing (in S1306 and S1307 in the flow in FIG. 13), which will be described later.

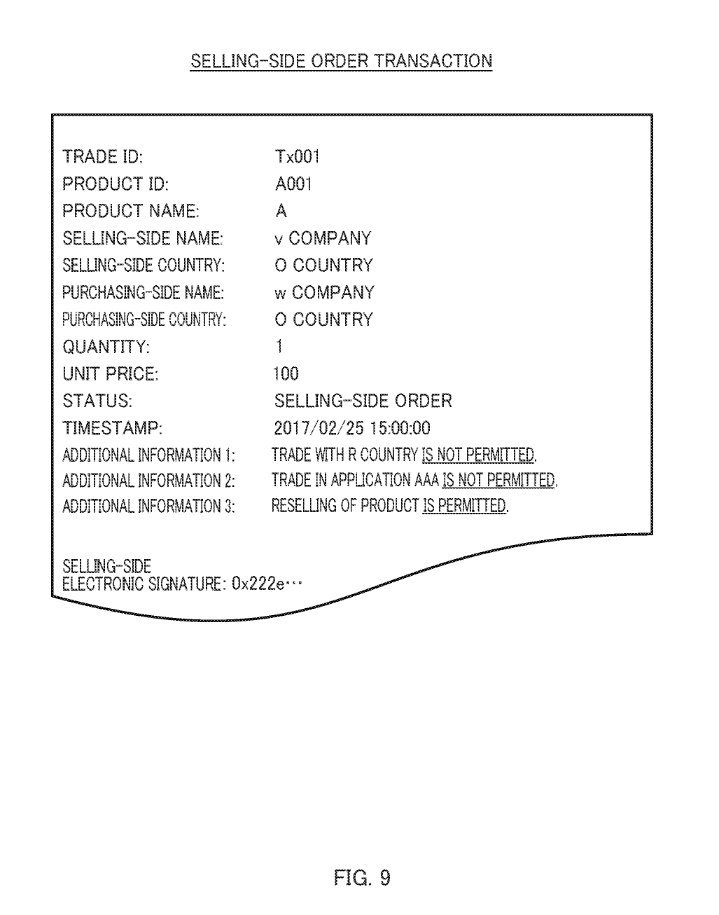

Subsequently, when receiving a click of a condition determining button 804 by the user on the new selling-side registration screen 800, the trader API 111 of the node 100 generates and registers transaction data (refer to a selling-side order transaction 900 in FIG. 9) including the individual information of new selling-side information 801 and selling-side condition 802 received via the new selling-side registration screen 800 (S604).

The transaction data is registered on the basis of agreements (existing sequence in the blockchain technology) of the individual nodes 100 connected via the P2P network 5.

Next, the traceability generating unit 113 of the node 100 refers to the selling-side order transaction 900 that is newly registered as mentioned above, adds a new record to the traceability data 116 (S605), and the processing ends.

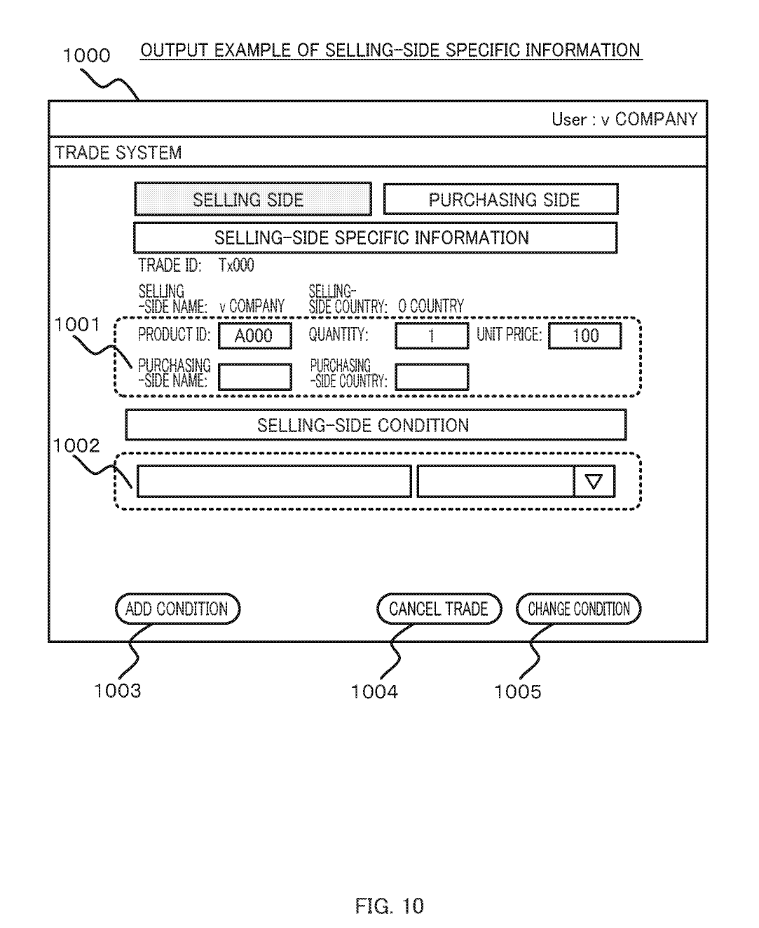

On the other hand, as a result of the above-mentioned determining result in S6011, on the selling-side list screen 700, in a case where the user clicks a (clickable-map) trade ID 702 in the selling-side list 701 (NO at S6011), the trader API 111 of the node 100 shifts a display screen of the client terminal 200 to a selling-side specific information display screen 1000 (FIG. 10) (S606).

Next, similarly to the above-mentioned S603, the trader API 111 of the node 100 receives an input of the user of selling-side information 1001 and a selling-side condition 1002 on the selling-side specific information display screen 1000 (S607).

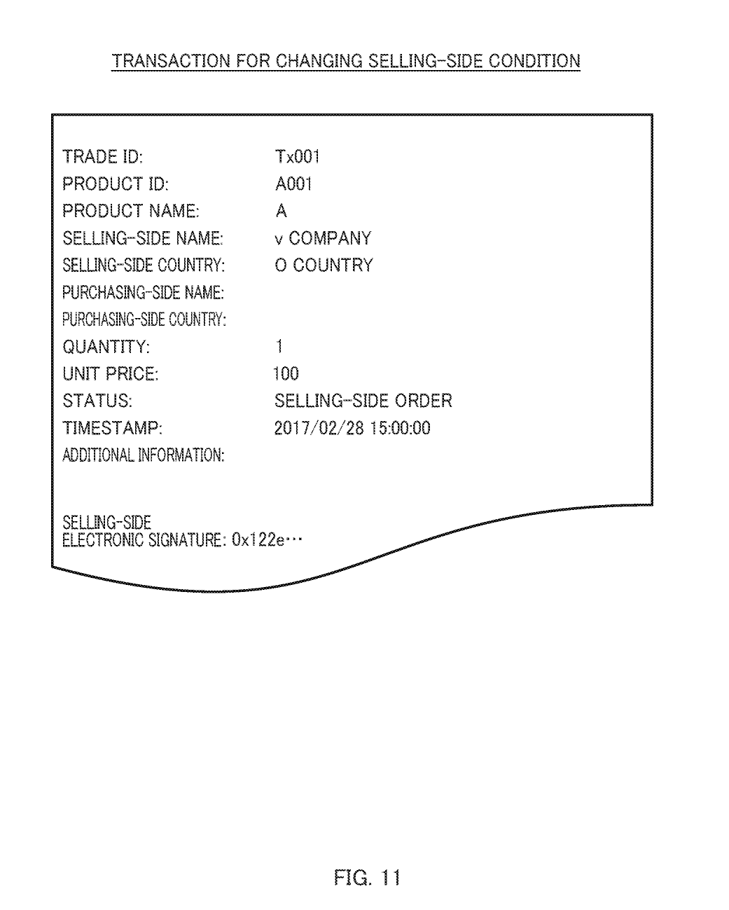

If the above-mentioned selling-side specific information display screen 1000 receives the input of the user and a condition change button 1005 is thereafter clicked (S6071: change), the trader API 111 of the node 100 that receives the click registers a selling-side condition changing transaction 1100 (FIG. 11) including the changed selling-side condition. It is assumed that the selling-side condition changing transaction 1100 is registered similarly to S604, on the basis of agreement of the individual nodes 100 connected via the P2P network 5. Note that the above-registered selling-side condition changing transaction 1100 is added to the traceability data 116 in S605.

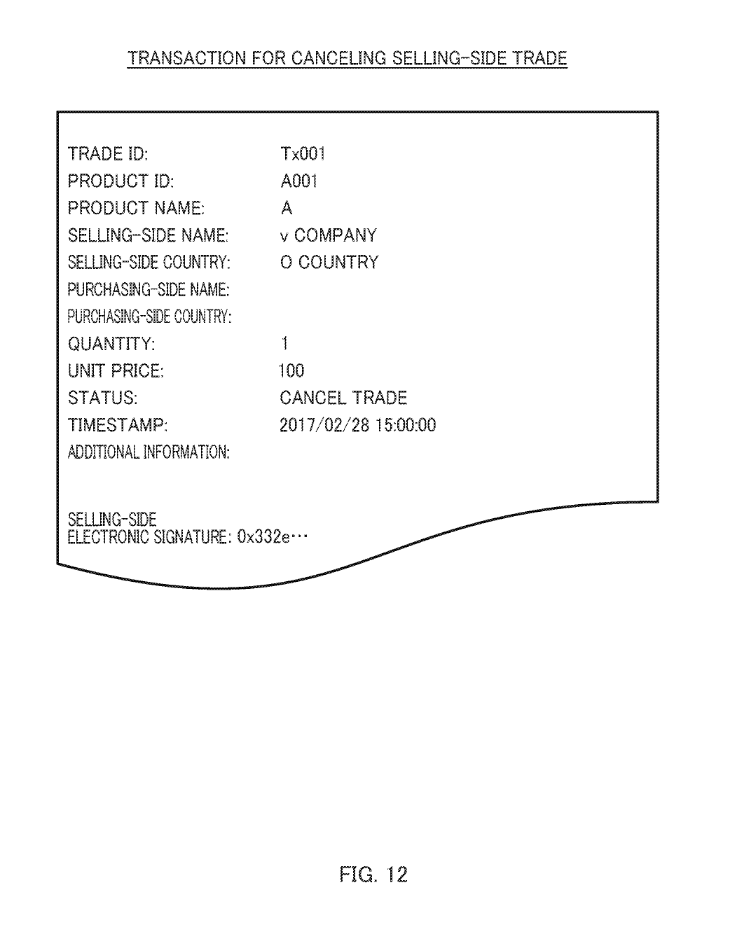

On the other hand, in a case where the above-mentioned selling-side specific information display screen 1000 receives the input of the user and a trade cancel button 1004 is thereafter clicked (S6071: cancel), the trader API 111 of the node 100 that receives the click registers a selling-side trade cancel transaction 1200 (FIG. 12) including information relating to a trade to be canceled. The selling-side trade cancel transaction 1200 is registered similarly to S604, on the basis of agreement of the individual nodes 100 connected via the P2P network 5. Herein, the registered selling-side trade cancel transaction 1200 is added to the traceability data 116 in S605.

Flow Example 2

Next, a description will be given of processing sequences when finishing or cancelling the trade by the purchasing side in the parties in charge with reference to drawings. FIG. 13 is a diagram showing a flow example 2 of a trade management method according to the embodiment. It is assumed that the flow is started by executing the trader API 111 of the node 100 via the network 1 and the P2P network 5 by using the client terminal 200 by the user (example: “w company”) as the purchasing side.

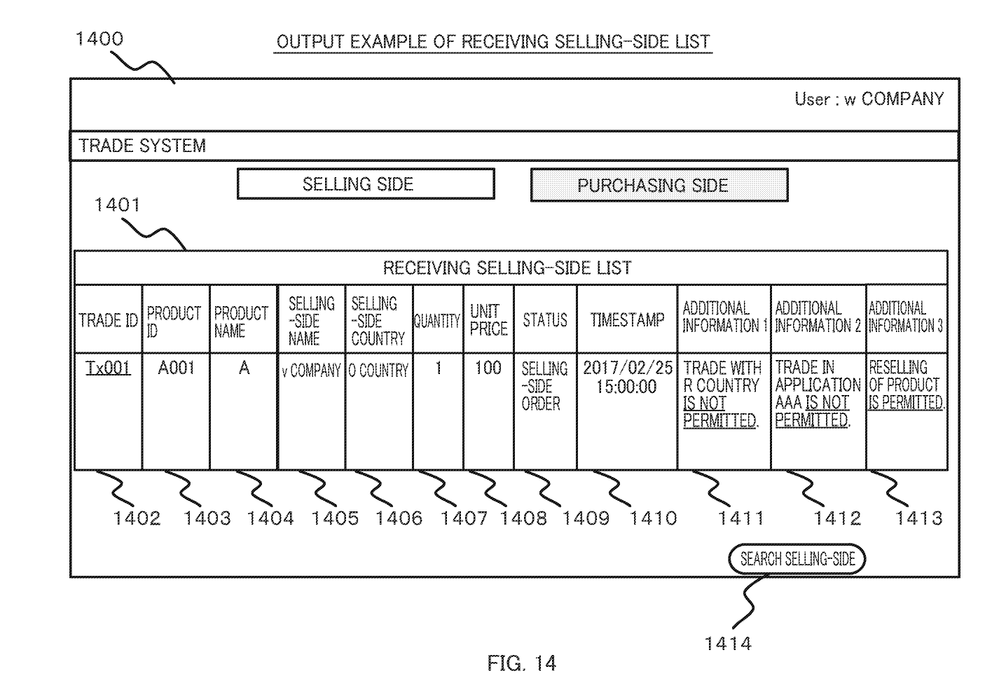

In this case, the trader API 111 of the node 100 reads the traceability data 116, specifies a record of the selling-side order in which identification information of the user (hereinafter, the purchasing-side user) as the above-mentioned purchasing side is registered to the purchasing-side name column 506, sets information included in the record as a receiving selling-side list 1401, and displays the receiving selling-side list screen 1400 (FIG. 14) on the client terminal 200 (S1301).

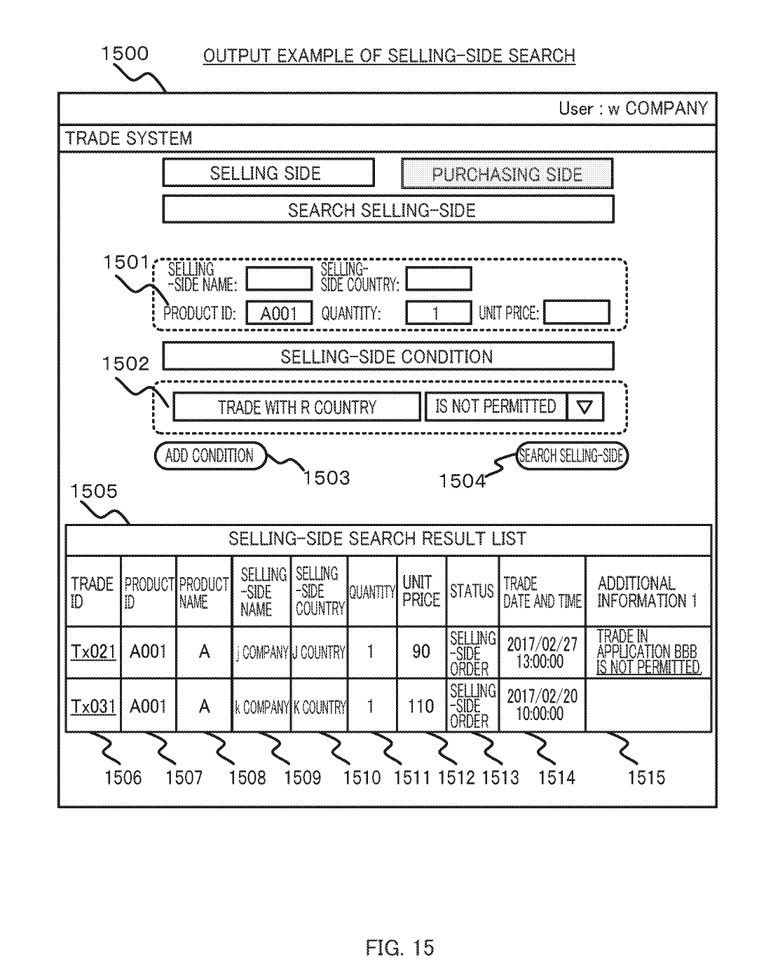

In a case where a selling-side search button 1414 is clicked on the above-mentioned receiving selling-side list screen 1400 (YES at S13011), the trader API 111 of the node 100 that receives the click shifts the display screen of the client terminal 200 to a selling-side search screen 1500 (FIG. 15) (S1302).

In this case, the trader API 111 of the node 100 receives inputs of the selling-side information 1501 and the selling-side condition 1502 relating to the selling side with which the above-mentioned purchasing-side user desires a trade, a selling product, and the like on the above-mentioned selling-side search screen 1500 (S1303). In an example in FIG. 15, the above-mentioned purchasing-side user (“w company”) inputs data to search selling-side order under a trade condition “the trade with R country is not permitted” regarding a quantity “1” of a product with a product ID “A001”.

In addition, by the trader API 111 of the node 100 in S1303, the selling-side order corresponding to the input selling-side information 1501 and the selling-side condition 1502 is obtained from the traceability data 116 in response to the click of a selling-side search button 1504 after the input of the above-mentioned purchasing-side user, and the obtained order is displayed on a selling-side search result list 1505.

When obtaining and displaying the above-mentioned data, the trader API 111 is configured to refer attribute information on the purchasing-side user of the user management data 114 and additional information 512 of the traceability data 116, that is, the trade conditions and compare the both and to display only the selling-side order in a case where the purchasing-side user is a purchasing side satisfying a prescription of the trade condition.

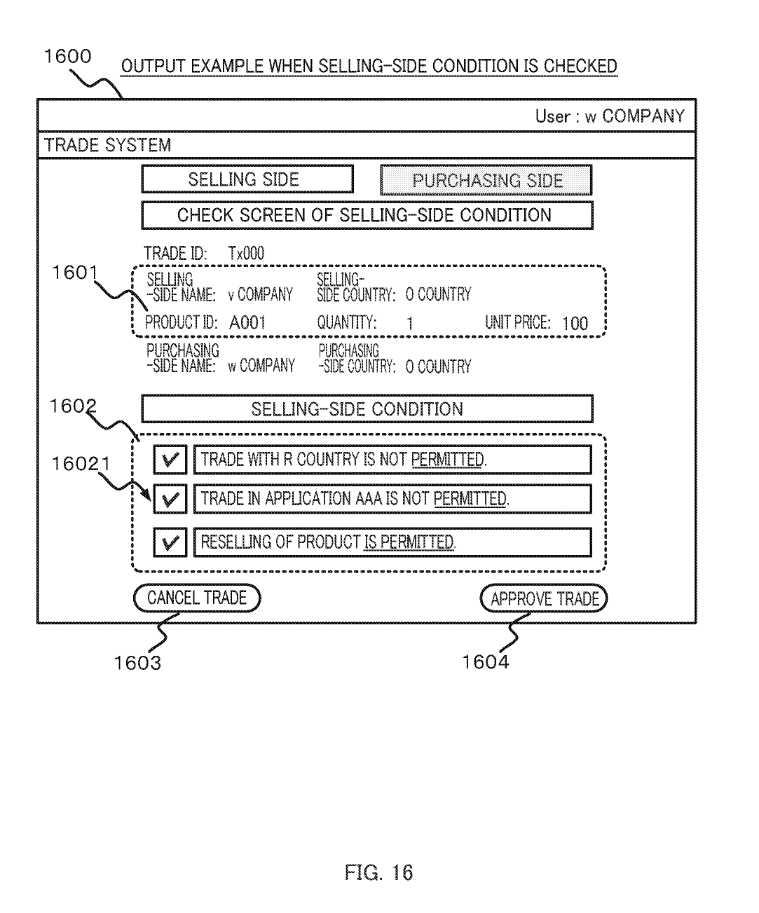

Subsequently, the trader API 111 of the node 100 receives a click operation to a trade ID 1402 or a trade ID 1506 (both are clickable) of the selling-side order shown by the receiving selling-side list 1401 or the selling-side search result list 1505, the display screen of the client terminal 200 is shifted to a selling-side condition checking screen 1600 (FIG. 16) (S1304). The above-mentioned purchasing-side user views the selling-side condition checking screen 1600 with the client terminal 200 to check selling-side information 1601 and a selling-side condition 1602.

Next, the trader API 111 of the node 100 determines the presence or absence of a checking input of a check box 16021 of the trade conditions in a column of the selling-side condition 1602 by the user who views the above-mentioned selling-side condition checking screen 1600 (S13041) over a predetermined time, for example. The checking input corresponds to agreement on the trade condition. If there is no checking input for a predetermined time as the above-mentioned determining result (NO at S13041), the trader API 111 of the node 100 shifts the processing to S1307.

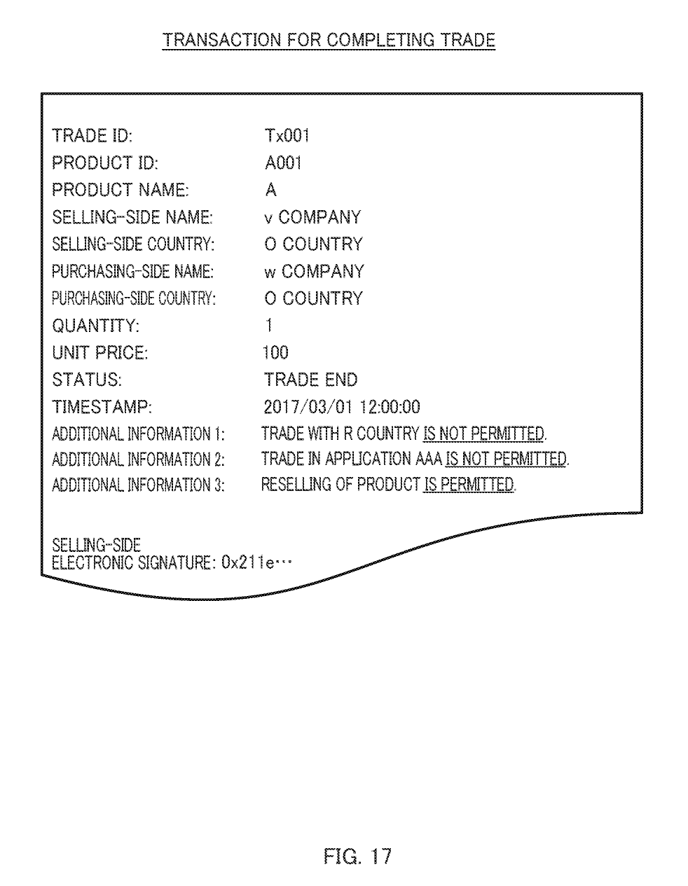

On the other hand, if there is a checking input in a predetermined time as the above-mentioned determining result (YES at S13041), provided that there is a checking input in the check box 16021, relating to all trade conditions in the column of the selling-side condition 1602, the trader API 111 of the node 100 receives a click of a trade approval button 1604 by the purchasing-side user, and generates and registers a trade-completed transaction 1700 (FIG. 17) (S1305). The trade-completed transaction 1700 is registered similarly to S604, on the basis of agreement of the individual nodes 100 connected via the P2P network 5.

In addition, the traceability generating unit 113 of the node 100 adds the above-mentioned registered trade-completed transaction 1700 to the traceability data 116 similarly to S605 (S1306), and the processing ends.

If there is no checking input for a predetermined time as the above-mentioned determining result in S13041 (NO at S13041), the trader API 111 of the node 100 performs processing for canceling the selling-side order from the receiving selling-side list 1400 in response to a click of a trade cancel button 1603 (S1307).

The processing is performed by the trader API 111, in a case where the receiving selling-side list 1401 includes at least one selling-side order and a predetermined selecting operation to the trade ID 1402 of any selling-side order is performed by the client terminal 200.

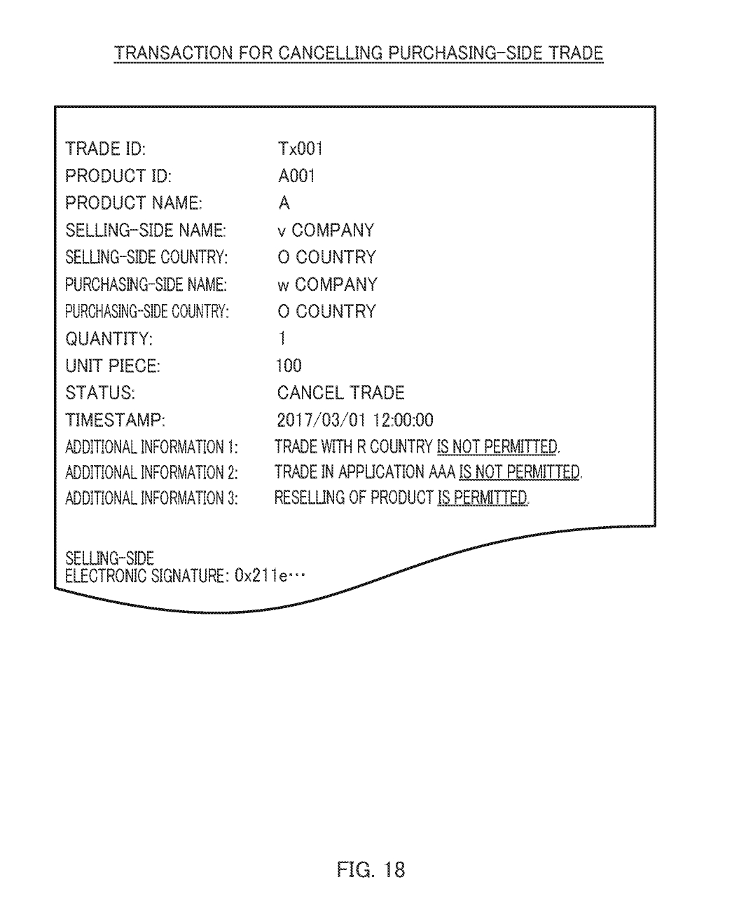

In addition, the trader API 111 in S1307 generates and registers a purchasing-side trade cancel transaction 1800 (FIG. 18) in response to a click operation of the trade cancel button 1603 of the purchasing-side user as mentioned above. The purchasing-side trade cancel transaction 1800 is registered on the basis of agreement of the individual nodes 100 connected via the P2P network 5 similarly to S604.

Further, the trader API 111 of the node 100 adds the registered purchasing-side trade cancel transaction 1800 in S1307 as mentioned above to the traceability data 116 (S1306), and the processing ends.

The specific description is given of best modes according to the embodiment as mentioned above. However, the invention is not limited thereto, and can be subject to various changes without departing from the scope thereof.

According to the embodiment, a condition of a trade after establishing purchase and sale is added to a trade, thereby enabling managing products and services even after the trade by a manufacturing side and a selling side of the products and the services. That is, a product and the like can be managed after trading the product and the like to reduce trade risks.

With the description in the specification, at least the following will be made clear. That is, with the trade management method according to the embodiment, regarding the commercial trade that is determined to be valid as the validity determining result, processing of the commercial trade may be performed in a case where, a node used by the party in charge obtains an agreement answer that the trade condition included in transaction data at the start point is observed even for the sequential commercial trade on the commercial product from the party in charge via a predetermined device.

Accordingly, when executing the commercial trade with the above-mentioned validity determination, it is possible to ensure, as a collateral, agreement that the trade condition of the commercial product is observed for one party in charge of the commercial trade, that is, a purchasing person of a commercial product, even for another commercial trade of the commercial product after the commercial trade. Additionally, it is possible to manage a product and the like after trading the product and the like to reduce trade risks.

Furthermore, with the trade management method according to the embodiment, the predetermined node that issues the transaction data on the occasion of selling may receive input or change of a trade condition of a commercial product to be sold via a predetermined device from the party in charge for the selling, and may include information on the trade condition subject to the input or the change in the transaction data for issuance.

Accordingly, the party in charge that sells commercial products can flexibly set the trade condition of a commercial product to be sold, and can perform a commercial trade properly corresponding to change in commercial environment or the like. Further, a product and the like can be properly managed after trading the product and the like to further reduce trade risks.

What is claimed is:

1. A trade management method implemented, in a system including a plurality of nodes that individually hold transaction data in a commercial trade by a distributed ledger, by a node used by a party in charge of the commercial trade, comprising:
with transaction data issued by a predetermined node on an occasion of selling a predetermined product being set as a start point, determining whether or not the commercial trade is valid on the basis of information on a trade condition of the product included in the transaction data at the start point, and preliminarily held party-in-charge information relating to the party in charge when performing each processing of a series of commercial trades for repeating purchase and sale of the product.

2. The trade management method according to claim 1, wherein the node used by the party in charge performs processing of the commercial trade in a case where, regarding the commercial trade determined to be valid by the determination, an agreement answer to observe the trade condition included in the transaction data at the start point is obtained from the party in charge via a predetermined device even in a sequential commercial trade of the product.

3. The trade management method according to claim 1, wherein the predetermined node that issues the transaction data on the occasion of selling, receives input or change of the trade condition of the product to be sold from the party in charge of selling via a predetermined device, and issues the information on the trade condition which has been input or changed, in a manner included in the transaction data.

4. A trade management system comprising:
a plurality of nodes that individually hold transaction data in a commercial trade by a distributed ledger,
wherein a node used by a party in charge of the commercial trade performs, with transaction data issued by a predetermined node on an occasion of selling a predetermined product being set as a start point, processing for determining whether or not the commercial trade is valid on the basis of information on a trade condition of the product included in the transaction data at the start point, and preliminarily held party-in-charge information relating to the party in charge when performing each processing of a series of commercial trades for repeating purchase and sale of the product.

5. A trade management device comprising:
a node that holds transaction data in a commercial trade and forms a distributed ledger system,
wherein the node includes
a calculating unit that performs, with transaction data issued by a predetermined node on an occasion of selling a predetermined product being set as a start point at the start point, processing for determining whether or not the commercial trade is valid on the basis of information on a trade condition of a product included in the transaction data at the start point, and preliminarily held party-in-charge information relating to the party in charge when performing each processing of a series of commercial trades for repeating purchase and sale of the product.

6. A non-transitory computer-readable medium containing a trade management program that causes a node that holds transaction data in a commercial trade and forms a distributed ledger system to, with transaction data issued by a predetermined node on an occasion of selling a predetermined product being set as a start point, determine whether or not the commercial trade is valid on the basis of information on a trade condition of the product included in the transaction data at the start point, and preliminarily held party-in-charge information relating to the party in charge when performing each processing of a series of commercial trades for repeating purchase and sale of the product
